(19) United States
(12) Patent Application Publication
(10) Pub. No.: US 2009/0026647 A1
(43) Pub. Date: Jan. 29, 2009

(54) Making a spunbond fleece from cellulosic filaments

(75) Inventors: Hans-Georg Geus, Niederkassel (DE); Hans-Bernd Klunter, Troisdorf (DE)

Correspondence Address: K.F. ROSS P.C., 5683 RIVERDALE AVENUE, SUITE 203 BOX 900, BRONX, NY, 10471-0900, US

(73) Assignee: Reifenhauser GmbH & Co. KG Maschinenfabrik

(21) Appl. No.: 12/004,446

(22) Filed: Dec. 20, 2007

(30) Foreign Application Priority Data
Dec. 22, 2006 (EP) 06026730.9

(51) Int. Cl. B29C 47/92

(52) U.S. Cl. 264/40.6; 425/72.2

(57) ABSTRACT

A spunbond fleece is made by passing cellulosic filaments from a spinneret in a travel direction through a cooling chamber having upstream and downstream compartments spaced apart in the travel direction. In each of the compartments a respective stream of cooling air is directed against the filaments. The cooling air of each stream has parameters of temperature, humidity, and flow rate. At least one of the parameters of one of the streams is varied such that it is different from corresponding parameter of the other stream.

### FIELD OF THE INVENTION

The present invention relates to making a spunbond fleece. More particularly this invention concerns a method of and apparatus for making such a fleece from cellulosic fibers or filaments.

### BACKGROUND OF THE INVENTION

Methods for the manufacture of carded fleeces from cellulosic filaments made by extruding a cellulose solution or dope through holes of a spinneret are known from practice. Compared with spunbond fleeces of plastic filaments these fleeces of cellulosic filaments have the advantage that they are biologically degradable relatively easily. In addition, fleeces of cellulosic filaments can be advantageously employed in hygiene products because of their relatively high absorbency. However, these fleeces of cellulosic fibers are not suitable for many applications since they have only inadequate strength. To improve their strength, these fleeces are mixed with polymers. This however has the disadvantage that in turn the biological degradation of these fleeces is delayed or prevented.

### OBJECTS OF THE INVENTION

It is therefore an object of the present invention to provide an improved method of making a spunbond fleece or nonwoven from cellulosic fibers.

Another object is the provision of such an improved method of making a spunbond fleece or nonwoven from cellulosic fibers that overcomes the above-given disadvantages, in particular that where spunbond fleeces can be manufactured of cellulosic filaments so that they are easily biologically degradable, have a high absorbency, and nevertheless have optimum strength characteristics.

A further object of the invention is an apparatus for carrying out the method according to the invention.

### SUMMARY OF THE INVENTION

A spunbond fleece is made by passing cellulosic filaments from a spinneret in a travel direction through a cooling chamber having upstream and downstream compartments spaced apart in the travel direction. In each of the compartments streams of cooling air are directed against the filaments. The cooling air of each of the plurality of stream has parameters of temperature, humidity, and flow rate. At least one of the parameters of the streams of one of the compartments is varied such that it is different from corresponding parameter of the streams of the other compartment.

It is within the scope of the invention that the two cooling compartments, of which there can be more than two, are arranged after one another or on top of one another in the normally downward travel direction of the filaments. Practically, the upstream cooling compartment is above the downstream cooling compartment. It is within the scope of the invention that the spinneret is arranged above or vertically above the upstream cooling compartment.

According to a particularly preferred embodiment of the invention the cellulosic filaments are Lyocell filaments. Lyocell filaments here means filaments which are spun from a solution of cellulose in a mixture of water and an organic substance, normally termed “dope.” It is within the scope of the invention that the solution is a mixture of water and a tertiary aminoxide is used. The tertiary aminoxide then is the organic substance mentioned above. Preferentially N-methylmorpholine-N-oxide (NMMO) is employed as tertiary aminoxide.

A preferred embodiment of the invention is characterized in that the concentration of the cellulose in the cellulose solution is 0.5 to 25% by weight, preferably 1 to 22% by weight. More preferably the concentration of the cellulose here is 1.5 to 21% by weight, most preferably 2 to 20% by weight.

It is within the scope of the invention that the flow rate or air supplied to the upstream cooling compartment is less than that supplied to the downstream cooling compartment. According to a recommended embodiment of the invention the ratio of the flow rate of air supplied to the upstream cooling compartment to the flow rate of air supplied to the downstream cooling compartment is 1:10 to 1:1, more preferably 1.5:10 to 6:10 and most preferably 1.5:10 to 4.5:10.

According to a preferred embodiment version of the method according to the invention the temperature of the cooling air entering the upstream cooling compartment is higher than the temperature of the cooling air entering the downstream cooling compartment. Practically, the temperature of the cooling air supplied to the upstream cooling compartment is 18 to 80° C. and the temperature of the cooling air supplied to the downstream cooling compartment 18 to 35° C.

According to an embodiment the humidity of the cooling air entering the two cooling compartments is between 60 and 100% relative humidity. The humidity of this cooling air supplied in these cooling compartments however at least corresponds to the humidity which is drawn in from the ambient air. It is also within the scope of the invention that mist whose relative humidity is greater than 100% is introduced in the upstream cooling compartment and/or the downstream cooling compartment.

It is advisable that after cooling in the cooling chamber the filaments are aerodynamically stretched and subsequently deposited on a placement device or support. Aerodynamic stretching practically takes place in a stretching unit downstream of the cooling chamber. The support is preferably a foraminous or screen conveyor.

A particularly preferred embodiment of the invention is characterized in that prior to placement on the support the filaments are treated such that at least partial coagulation of the cellulose in the filaments takes place. This treatment of the filaments for coagulation is preferably carried out after the aerodynamic stretching and prior to deposition on the support. The treatment is practically carried out with an aqueous medium, more preferably with water and/or steam and/or with an aqueous solution and/or with an aqueous mixture. Aqueous solution here means especially the solution of an organic substance in water, preferably an aqueous NMMO solution. Preferably the treatment with the aqueous medium is carried out by spraying, suitable spray heads or water atomizers being used. The locations in which the above-mentioned treatment of the filaments is preferably carried out on the apparatus according to the invention will be explained in more detail below.

A particularly preferred embodiment of the method according to the invention is characterized in that after deposition on the support of the filaments the fleece webbing formed is treated or washed with an aqueous medium and subsequently dewatered. Aqueous medium in this case also means more preferably water and/or steam and/or an aqueous solution and/or an aqueous mixture. Water or an aqueous NMMO solution is preferably employed as aqueous medium or washing fluid.

It is within the scope of the invention that the filaments are deposited on an air and water-permeable foraminous conveyor to form the fleece strip that is thence transported downstream. Thereafter, the fleece strip is treated/washed with the aqueous medium on another foraminous conveyor downstream of the deposition conveyor. It is within the scope of the invention that the fleece strip is dewatered after such washing treatment. Dewatering is practically carried out as vacuum treatment in a vacuum station and/or by squeezing water out of the fleece strip between a pair of rollers. According to the recommended embodiment the fleece strip is repeatedly treated with the aqueous medium and subsequently dewatered each time. According to a preferred embodiment version the treatment with the aqueous medium and the subsequent dewatering takes place at least three times. After final washing and dewatering treatment, drying of the fleece strip is recommended followed by winding-up of the fleece strip. It is also within the scope of the invention that the fleece strip prior to being dried is compacted for setting certain fleece strip characteristics, specifically according to a preferred embodiment version by water jet consolidation. In addition, avivages or sizing can also be applied to the fleece strip before drying of the fleece strip to create certain fleece characteristics.

To solve the technical problem the invention furthermore is an apparatus for carrying out the method according to the invention, with a spinneret, a cooling chamber, a stretching unit and a support. Filaments from a cellulose solution can be spun with the spinneret, and the cooling chamber is divided into at least two cooling compartments in which the filaments can be treated with process or cooling air of a different rate and/or different temperature and/or different humidity. The apparatus also comprises a cellulose solution supply by means of which the cellulose solution is fed to the spinneret.

The spinneret in accordance with the invention has a hole density of 0.5 to 9 hole/cm², preferably 1 to 8 hole/cm², more preferably 1.5 to 7.5 hole/cm². Very preferable is a hole density of 2 to 5 hole/cm² and most preferable is a hole density of 2.5 to 4.5 hole/cm², for example a hole density of 3.5 hole/cm². Hole means an aperture in the spinneret or in the nozzle plate of the spinneret through which a filament is extruded. The hole diameter is normally around 0.1 mm to 1 mm. According to an embodiment of the invention, the holes or the associated bores are arrayed in the nozzle plate in a uniform array. According to another embodiment the bores can be distributed to guarantee certain physical characteristics of the filaments with a hole density increasing on the nozzle plate toward the outer periphery. However it is also possible that the hole density decreases from the center of the nozzle plate outward.

It is within the scope of the invention that the cooling chamber is arranged at a spacing from the spinneret or from the downstream face of the nozzle plate of the spinneret. Preferably a monomer extraction device is arranged between the nozzle plate and the cooling chamber. The monomer extraction device sucks air from the filament-formation space directly below the nozzle plate. As a result, gases escaping with the filaments, more preferably decomposition products and the like, are removed from the system. It is also emphasized that with the monomer extraction device the airflow below the nozzle plate can be controlled in an advantageous manner.

According to the recommended embodiment the cooling chamber is connected with a draw-down passage via an intermediate passage. This draw-down passage forms the stretching unit of the apparatus. A very particularly preferred embodiment of the invention is characterized in that the connection or the transition region between the cooling chamber and the intermediate passage is basically closed and prevents the entry of air from the outside. Advantageously merely one supply of the process or cooling air in the cooling chamber takes place throughout the entire region of the cooling chamber, the intermediate passage and the draw-down passage and no air can get in from the outside apart from this.

Preferably the intermediate passage from the outlet of the cooling chamber converges toward the inlet of the draw-down passage, is of decreasing flow cross section downward. Here it is within the scope of the invention that the intermediate passage converges toward to the inlet of the draw-down passage with the flow cross section of the draw-down passage getting smaller downward. It is advisable that different pitch angles of the walls of this intermediate passage can be set. Preferably the geometry of the intermediate passage can be changed so long as air speed can be increased. In this manner, undesirable relaxations of the filaments that occur at high temperatures can be avoided.

It is within the scope of the invention that a deposition device with at least one diffuser is arranged between the stretching unit (draw-down passage) and the support on which the filaments are deposited. According to a particularly preferred embodiment of the invention the deposition device consists of an upstream diffuser and a downstream diffuser following the upstream diffuser. Here, an ambient air inlet gap is preferably provided between the upstream and the downstream diffuser. According to a highly recommended embodiment, the filaments are treated via this ambient air inlet gap such that coagulation of the cellulose takes place. Advantageously, an aqueous medium, preferably water and/or an aqueous solution of NMMO is sprayed in via the ambient air inlet gap. Here it is advisable that spray heads are arranged in the region of the ambient air inlet gap, via which the aqueous medium can be sprayed in the travel direction of the filaments. According to an embodiment of the invention, aqueous medium for the coagulation is supplied via apertures in the diffuser wall or in the diffuser walls. In this case, spray heads are advantageously integrated in the diffuser wall or in the diffuser walls via which the aqueous medium can be sprayed in the travel direction of the filaments. This atomizing-in through apertures in the diffuser wall or in the diffuser walls can take place in addition to the atomizing-in via the ambient air inlet gap.

It is within the scope of the invention that the support comprises at least one continuously moving foraminous conveyor for the spunbond fleece strip. At least one suction device is advantageously provided below this foraminous conveyor, by means of which air is sucked through the foraminous conveyor. Advantageously the suction device is a suction blower that can be controlled and/or regulated by the control means that also operates the cooling-air feeds for the cooling compartments.

The invention is based on the realization that with the method according to the invention and with the apparatus according to the invention spunbond fleeces can be produced from cellulosic filaments that have optimal mechanical characteristics, in particular very considerable strength. The spunbond fleeces manufactured according to the invention have a relatively high resistance to abrasion and other mechanical influences. Nevertheless, these spunbond fleeces of cellulosic fibers can be created relatively easily and with little expenditure. The fleeces manufactured according to the invention have a high absorbency and can be employed more preferably advantageously in hygiene products. Furthermore, the spunbond fleeces created according to the invention are biologically degradable without problems so that they can be more preferably composted as disposable article.

It is within the scope of the invention that the spunbond fleeces are manufactured from the cellulosic fibers according to the Reicofil IV method. This Reicofil IV method is extensively described in U.S. Pat. No. 6,918,750, which is herewith incorporated by reference. Advantageously, all features described there can also be employed with the present method according to the invention or with the present device according to the invention.

With the method according to the invention the division of the cooling chamber into at least two cooling compartments is initially of special importance. It is furthermore greatly preferred that the cooling chamber, intermediate passage and stretching unit are designed as a closed system, air being supplied only as process or cooling air in the cooling chamber and otherwise no air getting into the system from the outside. Additionally particularly advantageous within the scope of the invention is the division of the deposition device into at least two diffusers, an ambient air inlet gap being provided through which an aqueous medium is advantageously sprayed for coagulation of the cellulose.

### BRIEF DESCRIPTION OF THE DRAWING

The above and other objects, features, and advantages will become more readily apparent from the following description, reference being made to the accompanying drawing in which:

FIG. 1 is a largely schematic side view of an apparatus for carrying out the method of this invention; and

FIG. 2 is a large-scale view of the detail indicated at II in FIG. 1.

### SPECIFIC DESCRIPTION

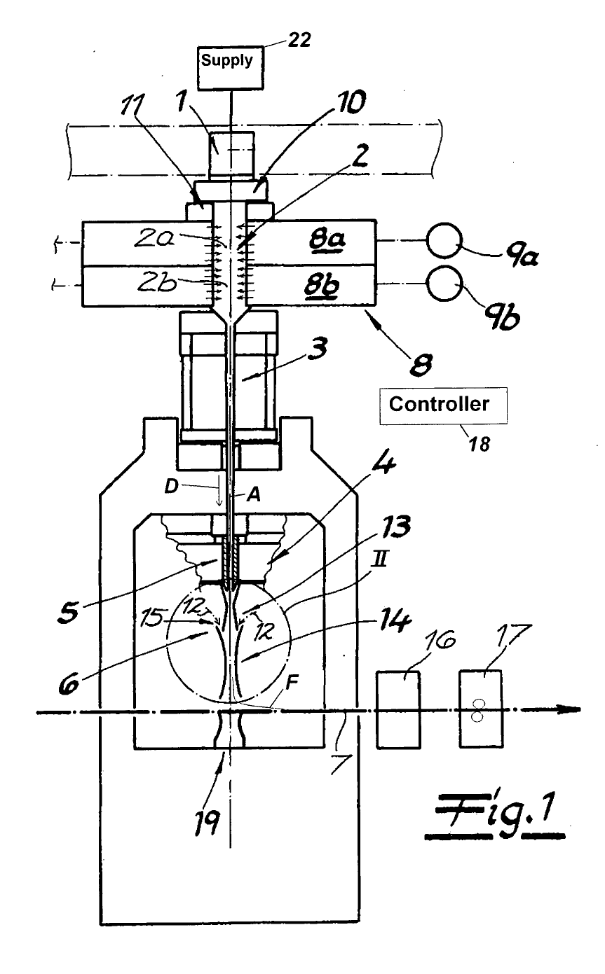

FIG. 1 shows an apparatus for the manufacture of a spunbond fleece of cellulosic filaments one of which is shown at F. Here, the filaments F are spun from a cellulose solution by means of a spinneret 1. To this end, the cellulose solution is supplied to the spinneret 1 from a cellulose solution feeding device or supply shown schematically at 22 in FIG. 1. After discharge from the spinneret 1, the cellulosic filaments F move in a travel direction D down through a cooling chamber 2 in which the filaments F come into contact with process or cooling air.

The cooling chamber 2 is followed in the direction D by the intermediate passage 3 and the intermediate passage 3 is followed by the draw-down passage 5 serving as a stretching unit 4. Underneath the draw-down passage 5 is a deposition device 6 and below the deposition device 6 the support 7 for deposition of the filaments F to form a fleece strip is provided. This support is a horizontally continuously moving foraminous conveyor 7 on which a mat of the filaments F collect.

In FIG. 1 it is evident that in the region of the cooling chamber 2 and the intermediate passage 3 as well as in the transition region between cooling chamber 2 and intermediate passage 3 is blocked off from air from the outside, except for the supply of the process or cooling air for cooling the filaments F in the cooling chamber 2. Preferably, except for the mentioned supply of the process or cooling air, no additional air supply from the outside takes place into the cooling chamber 2, intermediate passage 3 and draw-down passage 5. This is thus a closed system.

Preferably and in the illustrated embodiment, the filaments F are Lyocell filaments. According to a particularly preferred embodiment a solution of cellulose in a mixture of water and a tertiary aminoxide is employed as cellulose solution. The tertiary aminoxide is preferably NMMO. The concentration of the cellulose in the solution advantageously amounts to 2 to 19% by weight.

In FIG. 1 it is evident that according to the preferred embodiment between a downstream face of a nozzle plate 10 of the spinneret 1 and the cooling chamber 2 there is a monomer extraction device 11 that exhausts undesired gases generated during the spinning process, e.g. solvent vapors. Here, extraction advantageously is done without generating turbulence between the nozzle plate 10 and the monomer extraction device 11 so that the filaments F, which are vary fragile at this stage, can move downward intact.

The cooling chamber 2 in the illustrated embodiment is divided into upstream and downstream cooling compartments 2a and 2b. Next to the cooling chamber 2 an air supply unit 8 is arranged that itself is subdivided divided into an upper plenum 8a and a lower plenum 8b. From the two plenums 8a and 8b, process or cooling air streams with different convective heat dissipation capacities are supplied to the respective compartments 2a and 2b. Preferably, process air of different temperature can be supplied from the two plenums 8a and 8b. Advantageously process air with a temperature between 18° C. and 80° C. from the upper plenum 8a reaches the upstream cooling compartment 2a and process air with a temperature between 18° C. and 35° C. from the lower plenum 8b reaches the downstream or lower cooling compartment 2b. According to a particularly preferred embodiment of the invention the process air exiting from the upper plenum 8a has a higher temperature than the process air exiting from the lower plenum 8b. According to another embodiment, however, for the adjustment of special conditions, the process air exiting from the upper plenum 8a can also have a lower temperature than the process air exiting from the lower plenum 8b. Advantageously, respective blowers 9a and 9b are connected to each of the plenums 8a, 8b for supplying process air, these blowers 9a and 9b being operated by a controller 18. It is furthermore within the scope of the invention that the rates or the flow rates of the air supplied to the cooling compartments 2a and 2b are variable and preferably controllable by the controller 18. It is also within the scope of the invention that the temperature of the process air supplied to each of the cooling compartments 2a and 2b is controllable by respective unillustrated heaters also operated by the controller 18.

In FIG. 1 it was shown that the intermediate passage 3 from the outlet of the cooling chamber 2 to the inlet of the draw-down passage 5 in vertical sections converges downward, that is of decreasing flow cross section going downward, starting fairly wide and ending at the same width or cross-sectional size and shape as the upstream end of the draw-down passage 5. Preferably, different angles of the walls intermediate passage 3 can be set. According to a recommended embodiment version, the draw-down passage 5 also converges downward toward the deposition device 6. Advantageously, the flow cross section of the draw-down passage is also adjustable. Following aerodynamic stretching in the unit 4 (draw-down passage 5) the filaments F enter the deposition device 6.

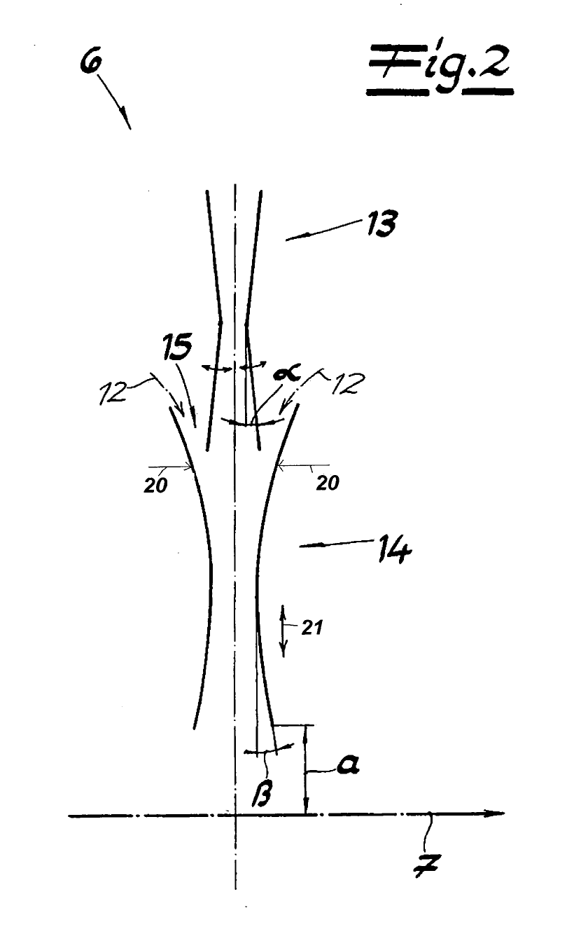

Preferably and in the illustrated embodiment (see especially FIG. 2) the deposition device 6 consists of an upstream diffuser 13 and a downstream diffuser 14 following the upstream diffuser. Between the upstream diffuser 13 and the downstream diffuser 14 there is an ambient air inlet gap 15. Preferably and in the illustrated embodiment the filaments F passing through the deposition device 6 through the ambient air inlet gap 15 are treated such that coagulation of the cellulose takes place. Advantageously, an aqueous medium is sprayed in through the ambient air inlet gap 15 for the coagulation of the cellulose as shown by arrow 12. To this end, spray heads not shown in more detail are preferably present in the region of the ambient air inlet gap 15. According to an embodiment of the invention, the substances promoting coagulation can also be sprayed in through suitable openings in the walls of the diffuser 14. This is shown schematically by arrows 20. Advantageously, an aqueous medium is sprayed in for coagulation of the cellulose also at 20.

FIG. 2 shows that each diffuser 13 and 14 comprises an upper converging part and a lower diverging part. Consequently each diffuser 13 and 14 has narrow center region between the upper converging part and the lower diverging part. In the upstream diffuser 13 a reduction of the high air speeds necessary for stretching the filaments F occurs at the end of the stretching unit 5. This results in a clear pressure recovery. The side walls of the lower part of the upstream diffuser 13 can be adjusted flap-like. In this manner an opening angle α of the diverging region 18 can be set. At the upstream end of the downstream diffuser 14, secondary air according to the injector principle can be sucked in through the ambient air inlet gap 15. The width of the ambient air inlet gap 15 is advantageously adjustable. Preferably, the opening angle β of the downstream end of the downstream diffuser 14 is also continuously adjustable. It is additionally recommended that the downstream diffuser 14 be made adjustable in height as indicated by double-headed arrow 21 so that the distance a of the downstream diffuser 14 to the foraminous conveyor 7 can be adjusted. In principle, all the characteristics affecting the two diffusers 13 and 14 and, which are described with respect to the Reicofil IV method in above-cited U.S. Pat. No. 6,918,750, can also be realized in the apparatus according to the invention described here.

According to a preferred embodiment of the invention the cooling chamber 2, intermediate passage 3, draw-down passage 5 and deposition device 6, except for the air supply in the cooling chamber 2 and the air inlet at the ambient air inlet gap 15 are a closed system. This means that advantageously no other air supply from the outside into these parts and or into anything between the cooling chamber 2, intermediate passage 3, intermediate passage 3, and draw-down passage 5.

The filaments F exiting the deposition device 6 are deposited on the foraminous conveyor 7 to form the fleece strip. Under this air and water-permeable foraminous conveyor 7, preferably and in the illustrated embodiment an extraction device 19 (FIG. 1) is provided that sucks air and wash fluid through the foraminous conveyor 7 from below. The fleece strip formed by the filaments F on the foraminous conveyor 7 is subsequently passed through a washing station 16 in which it is washed with an aqueous medium. This aqueous medium is preferably water and/or an aqueous NMMO solution or a mixture of water and NMMO. After this, the fleece strip is passed through a dewatering station 17 that dewaters it. Dewatering can take place through vacuum treatment and/or through squeezing in a squeezing system. It is within the scope of the invention that the fleece strip thereafter is again washed in a further washing station 16 and thereafter dewatered in a further dewatering station 17, wherein this process (washing and dewatering) is preferably repeated at least three times. After this, the fleece strip is advantageously dried and wound up according to a preferred embodiment.

We claim:

1. A method of making a spunbond fleece, the method comprising the steps of:
passing cellulosic filaments from a spinneret in a travel direction through a cooling chamber having upstream and downstream compartments spaced apart in the travel direction;
in each of the compartments directing a respective stream of cooling air against the filaments, the cooling air of each stream having parameters of temperature, humidity, and flow rate; and
varying at least one of the parameters of one of the streams such that it is different from corresponding parameter of the other stream.

2. The fleece-making method defined in claim 1 wherein the filaments are lyocell filaments.

3. The fleece-making method defined in claim 1, further comprising the steps of
feeding to the spinneret a solution of water and a tertiary aminoxide; and
passing the solution through holes in the spinneret such that the solution emerges from the spinneret as the filaments.

4. The fleece-making method defined in claim 3 wherein the solution has a concentration of cellulose of 0.5% to 25% by weight.

5. The fleece-making method defined in claim 4 wherein the concentration is 1% to 22% by weight.

6. The fleece-making method defined in claim 1 wherein the flow rate is the one parameter.

7. The fleece-making method defined in claim 6 wherein the flow rate in the upstream compartment forms with the flow rate in the downstream compartment a ratio of 1:10 to 1:1.

8. The fleece-making method defined in claim 7 wherein the ratio is 1.5:10 to 6:10.

9. The fleece-making method defined in claim 7 wherein the ratio is 1.5:10 to 4.5:10 5.

10. The fleece-making method defined in claim 1 wherein the one parameter is temperature.

11. The fleece-making method defined in claim 10 wherein the temperature of the cooling air of the upstream compartment is 18° C. to 80° C. and the temperature of the cooling air of the downstream compartment is 18° C. to 35° C.

12. The fleece-making method defined in claim 1 wherein the parameters other than the one parameter are held substantially constant.

13. The fleece-making method defined in claim 1, further comprising the steps of:
aerodynamically stretching the filaments in the compartments; and
depositing the filaments on a support after they leave the compartments.

14. The fleece-making method defined in claim 13, further comprising the step prior to deposition on the support of
treating the filaments such that cellulose therein coagulates.

15. The fleece-making method defined in claim 13 further comprising the step after deposition on the support of:
treating the filaments with an aqueous medium; and
thereafter dewatering the filaments.

16. An apparatus for making a spunbond fleece, the apparatus comprising:
a spinneret;
a cooling chamber downstream in a travel direction from the spinneret and having an upstream compartment and a downstream compartment;
means for feeding a cellulosic solution to the spinneret such that the solution is extruded as filaments from the holes and passes in the travel direction through the compartments;
respective upstream and downstream means for feeding respective streams of cooling air having respective parameters of temperature, humidity, and flow rate to the compartments to cool the passing filaments;
control means connected to the feeding means for varying at least one of the parameters of one of the streams such that it is different from corresponding parameter of the other stream;
means for stretching the filaments in the compartments; and
a support downstream of the stretching means oriented to receive the filaments on a support after they leave the compartments.

17. The fleece-making apparatus defined in claim 16 wherein the spinneret has a hole density of 0.5 to 9 hole/cm².

18. The fleece-making apparatus defined in claim 17 wherein the hole density is 1 to 8 hole/cm².

19. The fleece-making apparatus defined in claim 17 wherein the hole density is 1.5 to 7.5 hole/cm².

20. The fleece-making apparatus defined in claim 1 further comprising
a housing forming a passage closed to the exterior and extending from the cooling chamber through the stretching means.

21. The fleece-making apparatus defined in claim 1 further comprising
a diffuser downstream of the stretching means and upstream of the support.
